(19) United States
(12) Patent Application Publication
(10) Pub. No.: US 2022/0253578 A1
(43) Pub. Date: Aug. 11, 2022

(54) CONVERTING IMPLICIT DYNAMIC MODELS INTO EXPLICIT DYNAMIC MODELS

(71) Applicant: Palo Alto Research Center Incorporated, Palo Alto, CA (US)

(72) Inventors: Ion Matei, Sunnyvale, CA (US); Aleksandar B. Feldman, Santa Cruz, CA (US); Johan de Kleer, Los Altos, CA (US)

(73) Assignee: Palo Alto Research Center Incorporated, Palo Alto, CA (US)

(21) Appl. No.: 17/171,325

(22) Filed: Feb. 9, 2021

(51) Int. Cl. G06F 30/27

(52) U.S. Cl. CPC G06F 30/27; G06F 2111/08

(57) ABSTRACT

A nonlimiting example method for converting implicit dynamic models into explicit dynamic models comprises: performing a block lower triangular (BLT) transformation on equations of an implicit dynamic differential algebraic equation (DAE) model to yield a BLT representation of the implicit dynamic DAE model; performing a nonlinear block extraction for a diagonal of the BLT representation of the implicit dynamic DAE model to yield one or more nonlinear blocks and one or more linear blocks; constructing a surrogate causal model for each of the one or more nonlinear blocks; training the surrogate causal model for each of the one or more nonlinear blocks; and constructing an explicit dynamic ordinary differential equation (ODE) model that corresponds to the implicit dynamic DAE model based on the linear blocks and the surrogate causal model. The explicit ODE model may be useful for controlling operations, diagnosing issues, and prognosticating conditions within a physical system.

### FIELD OF INVENTION

This application relates to converting implicit dynamic models into explicit dynamic models. The resultant explicit dynamic models may be used as models for controlling the operation, diagnosing issues, and prognosticating conditions within a physical system.

### BACKGROUND

Model-based approaches are used for controlling the operation, diagnosing issues, and prognosticating conditions within a physical system. Such approaches require a mathematical model to represent the physical system's dynamic behavior. Such models are typically represented using ordinary differential equations (ODEs) and/or differential algebraic equations (DAEs).

More specifically, in modeling a system control, for example, a controller such that the closed loop system is identified that satisfies some objective (e.g., system stabilization, minimization of some cost function). In system diagnosis models and system prognosis models, problems are often based on state estimators (e.g., Kalman filter, particle filter). Such methods use the dynamic model to design the estimators. Most of the control and estimation techniques are designed to work with ODEs that have the form

\dot{x}=f(x, u), (EQ. 1)

where x is the state vector and u is the input vector.

In both control and diagnosis problems, the ODE is solved/integrated repeatedly over some time horizon. Therefore, ODE models can be classified into two categories: explicit and implicit. Explicit models (e.g., Euler method, Runge-Kutta method) propagate the state x through f(x, \dot{ }) to compute the state derivative and compute the state at the next time instant. For example, the Euler explicit method approximates the state derivative as

$$\dot{x} \approx \frac{1}{h} ( {x}_{k + 1} - {x}_{k} )$$

and computes the next state as xₖ₊ᵢ=xₖ+hf(xₖ, uₖ). In the case of implicit algorithms, a nonlinear set of equations (e.g., by using the Newton-Raphson algorithm) is solved to find its solution. Under a smoothness assumption of the ODE solution, the state derivative can be approximated as

$$\dot{x} \approx \frac{1}{h} ( {x}_{k} - {x}_{k - 1} ) ,$$

and to find xₖ the nonlinear set of equations xₖ−xₖ₋₁−hf(xₖ, uₖ)=0 is solved. Therefore, the implicit methods are more computationally expensive since an inner iteration loop is needed to find the current state. Implicit methods work better for a particular class of systems called stiff systems, where both fast and slow dynamic responses are present.

Many mechanical, fluid, and/or thermal systems within a physical system cannot be represented as ODEs, but as DAEs of the form:

F(\dot{x}, x, u)=0. (EQ. 2)

This is an implicit representation, where x cannot be represented analytically as a function of the state and input. Such mechanical, fluid, and/or thermal systems can sometimes be brought into an ODE form by using index reduction techniques. When index reduction fails to transform a DAE into an ODE, a Newton-Raphson algorithm is used to compute the solutions of algebraic loops, or nonlinear equations that cannot be solved symbolically. This operation is numerically expensive since the operation requires the inversion of a Jacobian matrix, which has O(n³) complexity, where n is the number equations. A number of explicit ODE models were integrated with deep learning platforms (DL) (e.g., PyTorch, TensorFlow, JAX, Autograd) and support automatic differentiation. Due to the causal nature of the backpropagation algorithm, the DL platforms support only ODEs as models for dynamic systems, and only explicit ODE models. Hence a large class of physical systems and the mechanical, fluid, and/or thermal systems thereof cannot be used within the DL platforms.

### SUMMARY OF INVENTION

This application relates to converting implicit dynamic models into explicit dynamic models. The resultant explicit dynamic models may be used as models for controlling the operation, diagnosing issues, and prognosticating conditions within a physical system.

The present disclosure includes a method comprising: performing a block lower triangular (BLT) transformation on equations of an implicit dynamic differential algebraic equation (DAE) model to yield a BLT representation of the implicit dynamic DAE model; performing a nonlinear block extraction for a diagonal of the BLT representation of the implicit dynamic DAE model to yield one or more nonlinear blocks and one or more linear blocks; constructing a surrogate causal model for each of the one or more nonlinear blocks; training the surrogate causal model for each of the one or more nonlinear blocks; and constructing an explicit dynamic ordinary differential equation (ODE) model that corresponds to the implicit dynamic DAE model based on the linear blocks and the surrogate causal model. The resultant explicit ODE model may be used as models for controlling the operation, diagnosing issues, and prognosticating conditions within a physical system.

The present disclosure also includes a system comprising: a processor; a memory coupled to the processor; and instructions provided to the memory, wherein the instructions are executable by the processor to cause the foregoing method to be performed.

The present disclosure includes a method comprising: controlling system variables for a chemical reactor (or other physical system like a distillation column; an automobile engine; an HVAC system; a robot or a portion thereof; a vehicle or a portion thereof; an electrical network; a distribution network system; a thermodynamic system) using a controller based on an explicit dynamic ordinary differential equation (ODE) model derived from an implicit dynamic differential algebraic equation (DAE) model, wherein the derivation uses a block lower triangular (BLT) transformation of the DAE model and a trained surrogate causal model that replaces nonlinear blocks of the BLT.

The present disclosure also includes a chemical reactor (or other physical system like a distillation column; an automobile engine; an HVAC system; a robot or a portion thereof; a vehicle or a portion thereof; an electrical network; a distribution network system; a thermodynamic system) comprising: a processor; a memory coupled to the processor; and instructions provided to the memory, wherein the instructions are executable by the processor to cause the foregoing method to be performed.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a diagram of a method of the present disclosure that converts implicit dynamic DAE models for a physics-based system of a physical system into explicit dynamic ODE models.

FIG. 2 is a diagram of the pendulum modeled in a nonlimiting example of the present disclosure.

FIG. 3 is a block lower triangular (BLT) transformation representation for the pendulum example.

FIG. 4 is an updated BLT transformation representation for the pendulum example based on a method of the present disclosure.

FIG. 5 is a plot of a nonlimiting example of sampling of an input space used to generate training data for the pendulum example.

FIG. 6 is a plot of angular acceleration (\ddot{φ}) as a function of angle (φ) and angular velocity (\dot{φ}).

FIG. 7 is a plot of the normalized magnitudes of the sensitivity of the angular acceleration with respect to the angle for the pendulum example.

FIG. 8 is a plot of the normalized magnitudes of the sensitivity of the angular acceleration with respect to the angular velocity for the pendulum example.

FIG. 9 is a plot of a nonlimiting example of sampling of an input space used to generate training data for the pendulum example where sensitivity is considered.

FIG. 10 is a plot of the angular acceleration as a function of the angle and angular velocity for the pendulum example.

FIG. 11 is a plot of the sensitivity as a function of the angular acceleration with respect to the angle for the pendulum example.

FIG. 12 is a plot of the sensitivity as a function of the angular acceleration with respect to the angular velocity for the pendulum example.

FIG. 13 is a histogram of the prediction error for the pendulum example angular acceleration.

FIG. 14 is a fitted normal distribution (mean=−5.934495×10⁻⁶ and variance=0.00058704143) of FIG. 13.

FIGS. 15A and 15B include plots of the statistics of the error between the variable of the implicit dynamic DAE model and the explicit dynamic ODE model for the pendulum example.

FIG. 16 is a BLT transformation representation for a chemical process reactor example.

FIG. 17 is an updated BLT transformation representation for the chemical process reactor example based on a method of the present disclosure.

FIG. 18 is a plot of the evolution of the variable V under feedback control for each of the implicit dynamic DAE model (circles) and the explicit dynamic ODE model (squares) for the chemical process reactor example.

FIG. 19 is a plot of the evolution of the variable C_{B} under feedback control for each of the implicit dynamic DAE model (circles) and the explicit dynamic ODE model (squares) for the chemical process reactor example.

FIG. 20 is a plot of the evolution of the variable C_{C} under feedback control for each of the implicit dynamic DAE model (circles) and the explicit dynamic ODE model (squares) for the chemical process reactor example.

### DETAILED DESCRIPTION

This application relates to converting implicit dynamic models into explicit dynamic models. As described above, implicit models are more computationally expensive than explicit dynamic models. Therefore, the physical systems or portions thereof (e.g., computers of a power plant or chemical plant) implementing the explicit dynamic models described herein may run faster and allow for real-time modeling where use of the corresponding implicit dynamic model would not be capable of real-time modeling.

Further, the approach to generating the training data described herein for the surrogate causal models that convert nonlinear portions of the DAE models to linear relationships advantageously produces large amounts of training data, which improves the accuracy of the final explicit dynamic ODE model.

Additionally, some physical systems like robots (especially robot dynamics), vehicles (especially vehicle dynamics), electrical networks, distribution network systems, and thermodynamic systems cannot be represented by ODE models and the computationally expensive implicit dynamic models are required. Advantageously, the methods of the present provide a straightforward method for converting implicit dynamic models into explicit dynamic models. The methods described herein may provide a conversion path to transform said DAE models into explicit dynamic models that use ODEs, which, again, provides less computational burden and may allow for real-time modeling where it was not available with the DAE models. Moreover, ODE representations enable the use of causal methods in control and diagnosis, enlarging the class of methods that can be applied for analysis of such systems.

As used herein, the term “physical system” refers to a portion of the physical universe chosen for analysis. For example a physical system may be a polymer synthesis reactor, a distillation column, an automobile engine, and the like. The physical systems described herein are not limited by complexity and may be very simple (e.g., a spring) or complex (e.g., an automobile engine). Modeling physical systems, as described herein, involves modeling the physics (e.g., mechanics, fluid flow dynamics, thermal storage and flow, and the like, and any combination thereof) of the physical system. When modeling the physical system, the individual physics aspects being modeled are referred to as physics-based systems and, more specifically, mechanical systems, fluid systems, thermal systems, and the like, and hybrid systems that incorporate one or more aspects of any combination of the foregoing systems. The models of physical systems may include multiple types of physics-based systems and one or more of an individual physics-based system. For example, when modeling a distillation column, each of the individual zones being temperature controlled may be modelled as separate thermal systems. In another example, a polymer synthesis reactor model may include one or more fluid systems to describe the flow of reactants and products through various stages in the reactor, one or more thermal systems to describe the temperature changes in the various stages in the reactor, and, if a mechanical implement like a stirrer is used to maintain polymer bed movement, one or more mechanical systems may be used to describe the movement of the stirrer.

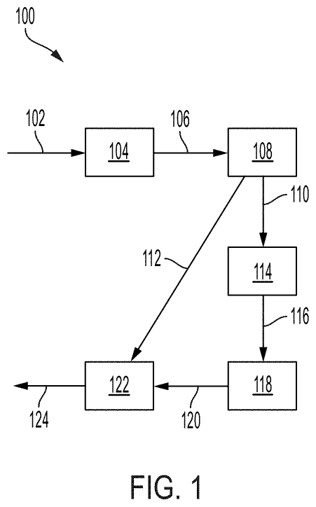

FIG. 1 is a diagram of a method 100 of the present disclosure that converts implicit dynamic DAE models 102 for a physics-based system of a physical system into explicit dynamic ODE models 124. First, a block lower triangular (BLT) transformation 104 is performed on equations in the implicit dynamic DAE model 102 to yield a BLT representation 106 of the implicit dynamic DAE models 102. Then, a nonlinear block extraction 108 for a diagonal of the BLT representation 106 of the implicit dynamic DAE model 102 is performed to yield nonlinear blocks 110 and linear blocks 112. A surrogate causal model 116 is then constructed 114 for the nonlinear blocks 110. The surrogate causal model 116 is then trained 118 to yield a trained surrogate causal model 120. The trained surrogate causal model 120 along with the linear blocks 112 are then used to construct 122 the explicit dynamic ODE model 124 that corresponds to the implicit dynamic DAE model 102. The resultant explicit dynamic ODE model 124 may then be applied to the physical system, for example, to control the operation, diagnose issues, and prognosticate conditions within the physical system.

Operators of the physical system may adjust the physical system and/or the operational parameters of the physical system based on outputs of the resultant explicit dynamic ODE model 124. For example, an explicit dynamic ODE model that includes thermal models for diagnosing issues relative to a distillation column may have outputs that include identifying heater malfunction where the operator may replace a heater to rectify the issue diagnosed by the explicit dynamic ODE model.

Further, as data from the physical system is gathered, the implicit dynamic DAE model may be updated. Accordingly, the explicit dynamic ODE model may be updated by performing methods described herein (e.g., method 100 of FIG. 1 or variations thereof).

To facilitate a better understanding of the methods of the present disclosure, the following nonlimiting example using a pendulum system is given. In no way should the following example be read to limit, or to define, the scope of the invention.

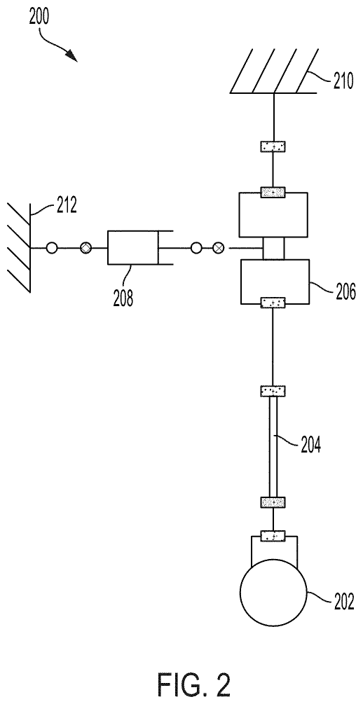

FIG. 2 is a diagram of the pendulum being modeled in this nonlimiting example. The physical system (the pendulum) was modeled using Modelica language. FIG. 2 represents the ground truth 200 of the model. In FIG. 2, the pendulum body 202 is attached to a fixed length, straight bar 204. The bar 204 is attached to a pivot mechanism 206 that has a damper 208 and is fixed to a vertical support 210 and a horizontal support 212.

The pendulum position is denoted using the tuple (x, y) and angle using φ. After flattening the system model, the following set of equations models the pendulum behavior.

m\ddot{x}=fₓ (EQ. 3)

mÿ=−mg+f_{y} (EQ. 4)

I\ddot{φ}+d\dot{φ}−L(f_{y} cos(φ)−fₓ sin(φ))=0 (EQ. 5)

x=L cos(φ) (EQ. 6)

y=L sin(φ) (EQ. 7)

where m is the mass of the pendulum body 202, d is the damping coefficient of the dampener 208, L is the length of the bar 204, and I is the mass moment of inertia.

Because of EQ. 5, the set of equations (EQ. 3-7) is an implicit dynamic DAE model. Therefore, the methods described herein were applied to the implicit dynamic DAE model to yield an explicit dynamic ODE model.

First, the implicit dynamic DAE model is converted to a BLT representation using a BLT transformation. To achieve this, the structural information from the implicit dynamic DAE model is extracted, and a matching problem is solved that matches variables with equations, which can be done with modeling tools supporting Modelica language (e.g., Dymola, OpenModelica, JModelica). However, if the matching fails, that is, if not all variable are associated to equations, index reduction algorithms (e.g., Pantelides's algorithm) can be used to create new equation through repeated differentiation. Therefore, the methods of the present disclosure may include performing repeated differentiation of the implicit dynamic DAE model, or a portion thereof, to produce index reduction algorithms and, then, performing the BLT transformation on the implicit dynamic DAE model comprising the index reduction algorithms.

In the BLT transformation, the solution of implicit dynamic DAE model is reduced to many smaller sub-systems whose dimensions correspond to that of the blocks on the main diagonal. The BLT transformation may be performed using Tarjan's algorithm, Kosaraju's algorithm, a path-based strong component algorithm, and the like, and any hybrid thereof. Although both algorithms run in linear time, Tarjan's algorithm is preferred because it is faster due to smaller linear constants. In this example, the BLT transformation is solved using Tarjan's algorithm.

Further, during the BLT transformation, two additional steps may be applied: solving linear equations symbolically and simplifying nonlinear equations with a tearing method. In the tearing method, part of the variable in a block that correspond to a set of nonlinear equations, are solved in terms of the remaining variables. As a result of the tearing method, the Newton-Raphson algorithm may be applied to a smaller number of variables. While other algorithms like gradient-based optimization algorithms may be used, the Newton-Raphson algorithm is preferred since it has a quadratic rate of convergence, unlike gradient-based optimization algorithms that have linear rate of convergence.

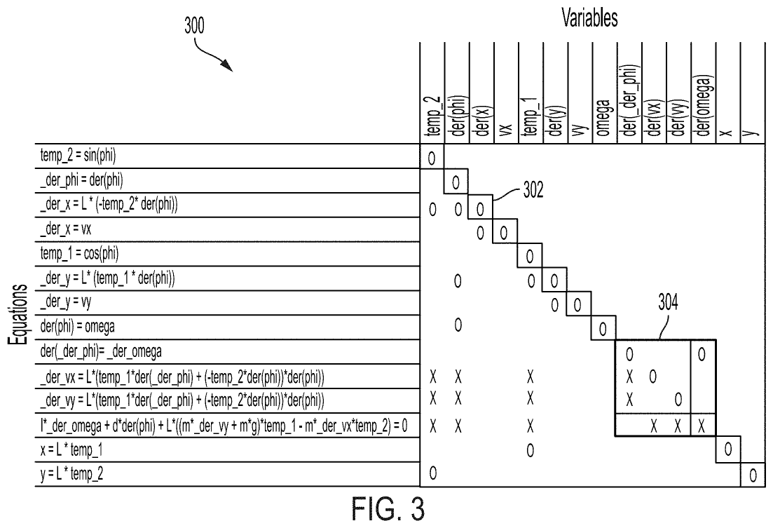

FIG. 3 is the BLT representation 300 for the pendulum example. The BLT representation includes linear blocks 302 and nonlinear blocks 304. Linear blocks 302 are equations that depend on one or more variables that are known system parameters and/or previously calculated variables. For example, in FIG. 3, the fifth equation (temp_1=cos(phi)) calculates temp_1 based on the known system parameter phi, and the third equation (_der_x=L*(−temp_2*der(phi)) calculated _der_x based on the previously calculated temp_2 from the first equation, the previous calculated der(phi), and the known system parameter L. The nonlinear block 304 represents the angular acceleration of the pendulum.

Nonlinear blocks 304 are the result of tearing nonlinear equations. The tearing method first tears the all but one of the variables (_der_phi, der(vx), der(vy) in FIG. 3, EQ. 8-10 below) in the nonlinear block and applies a Newton-Raphson algorithm to the remaining variable (_der_omega in FIG. 3, EQ. 11 below) to arrive at the ninth through twelfth equations. Generally, the tearing method determines the variables to which the Newton-Raphson algorithm is applied. Therefore, _der_omega is the unknown variable.

der(_der_phi)=_der_omega (EQ. 8)

_der_vx=L*(temp_1*der(_der_phi)+(−temp_2*der(phi))*der(phi)) (EQ. 9)

_der_vy=L*(temp_1*der(_der_phi)+(−temp_2*der(phi))*der(phi)) (EQ. 10)

I*_der_omega+d*der(phi)+L*((m*_der_vy+m*g)*temp_1−m*_der_vx*temp_2)=0 (EQ. 11)

As a result of the tearing method, within the BLT representation 300 the ninth equation depends on the result of the twelfth equation, the twelfth equation depends on the result of the tenth and eleventh equations, and the tenth and eleventh equations depend on the results of the ninth equation.

After the BLT representation is acquired, the nonlinear blocks (e.g., nonlinear block 304 of FIG. 3) is extracted and one or more surrogate causal models are constructed for each of the nonlinear blocks. In the pendulum example, there is only one nonlinear block, but BLT representations derived from other physical systems may have more than one nonlinear block.

In the pendulum example, the ninth through twelfth equations form the nonlinear block 304. This block 304 uses two variables, namely phi, der(phi) as inputs and computes _der_omega. Therefore, the one or more surrogate causal models for this block 304 of equations that has as inputs phi, der(phi) and compute as output _der_omega. In this example, the map g: [symbol] ²→ [symbol] is used, where _der_omega=g(phi, der(phi); w), where w is a set of parameters of the map. The map g is the surrogate causal model, and more than one map g may be constructed and trained. The objective is to train the parameters w (in the next step) so that the map g acts as a surrogate for the block diagonal that computes _der_omega, hence avoiding the need to use the Newton-Raphson algorithm at each time instant during the simulation process. Again, solving the Newton-Raphson algorithm is an iterative process that takes up valuable computation time and resources. Removing the Newton-Raphson algorithm from the model being used improves computational speed and allows for real-time computations where said real-time computations may not have been previously available.

The one or more surrogate causal models corresponding to each nonlinear block of the BLT representation are trained using training data. The training data is derived by extracting the original system of equations from the implicit dynamic DAE model corresponding to the nonlinear block and randomly sampling from the input space to calculate the output of the Newton-Raphson algorithm. In the pendulum example, 100,000 input samples for the variable phi and der(phi) were generated, and the nonlinear equation EQ. 11 above. In this pendulum example, there was only one nonlinear equation (Newton-Raphson algorithm) to solve for, so the operation is fast. In the pendulum example, the CVODE DAE solver was used to generate 100,000 pairs of (x⁽ⁱ⁾,y⁽ⁱⁱ⁾), where x=(phi, der(phi) and y=_der_omega.

The map g can be parameterized using a variety of training architectures. Examples of training architectures include, but are not limited to, neural networks, machine learning, decision trees/random forest methods, kernal methods, and the like, and any ensemble thereof. Examples of neural networks include, but are not limited to, perceptron, feed forward, radial basis, deep feed forward, recurrent neural network, long-short term memory, gated recurrent unit, auto encoder, variational auto encoder, denoising auto encoder, sparse auto encoder, Hopfield network, Boltzmann machine, restricted Boltzmann machine, deep belief network, deep convolutional network, deconvolutional network, deep convolutional inverse graphics network, generative adversarial network, liquid state machine, extreme learning machine, echo state network, deep residual network, Kohonen network, support vector machine, neural turning machine, and the like. Examples of kernal methods include, but are not limited to, kernel perceptron, Gaussian processes, principal components analysis, canonical correlation analysis, ridge regression, spectral clustering, linear adaptive filters, and the like. While the foregoing are applicable as training architectures, preferred training architectures are simple so as not to add complexity to the methods and systems described herein.

In the pendulum example, a neural network with one hidden layer of size 20 and tanh as activation function was used. In this example, the aim was simplicity, but more complex neural networks may be used in the methods described herein. In particular for the pendulum example, map g is expressed as EQ. 12.

g(x)=W^{[1]}(tanh(W^{[0]}x+b^{[0]}))+b^{[1]} (EQ. 12)

where W^{[1]}, b^{[1]}, W^{[0]}, and b^{[0]} are weights of the neural network.

In the pendulum example, Pytorch was used to train the surrogate causal model resulting in a training mean-square-error (MSE) of 3.446529e-07. Note that in this example a very small prediction error was desired to avoid error accumulations when using the surrogate causal model. Other motivations may be used when deciding the surrogate causal model is complete.

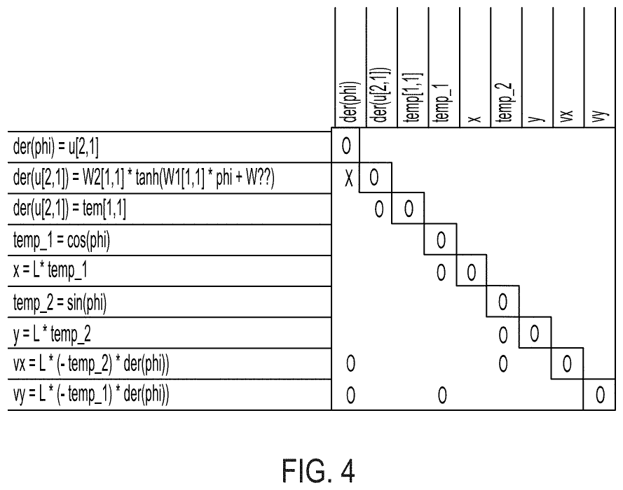

Finally, the surrogate causal model and the linear blocks (e.g., linear blocks 302 from FIG. 3) are used to construct the explicit dynamic ODE model. This may be achieved through rebuilding the BLT representation using the surrogate causal model and the linear blocks. For example, in the pendulum example, the weights of the trained neural networks were extracted and expressed in the Modelica language and generated neural network functions in the Modelica language. These generated neural network functions based on the surrogate causal model were used to build the BLT representation shown in FIG. 4. The BLT representation of FIG. 4 was then substituted for the nonlinear block 304 of FIG. 3 (where overlapping equation from the two BLT representations like y=L*temp_2 are consolidated) to yield a BLT representation with a pure triangular form that does not require the use of Newton-Raphson algorithms (nonlinear blocks). This BLT representation with no nonlinear diagonal blocks was the basis for the final explicit dynamic ODE model.

Specifically for the pendulum example, the system of equations for the pendulum with surrogate causal model insertion can be expressed as EQ. 13-15 instead of EQ. 3-7.

\ddot{φ}=W^{[1]}(tanh(W^{[0]}[φ, \dot{φ}]^{T}+b^{[0]}))+b^{[1]}, φ(0)=φ₀, \dot{φ}(0)=\dot{φ}₀ (EQ. 13)

x=L cos(φ) (EQ. 14)

y=L sin(φ) (EQ. 15)

EQ. 14 and 15 can be seen as outputs of the system, not requiring numerical integration. Hence, the explicit dynamic ODE model has been obtained. That is, the obtained surrogate model lost its explicit dependency on system parameters. However, said dependency can be preserved by using the system parameters (e.g., the pendulum length L) as inputs for the surrogate model.

In the pendulum example above, the training data was generated by uniformly sampling the input space. However, other approaches may be taken. For example, a sensitivity-based sampling approach may be used to generate the training data. In a sensitivity-based sampling approach to generate training data, more data is extracted from areas of the input space where the solution is more sensitive.

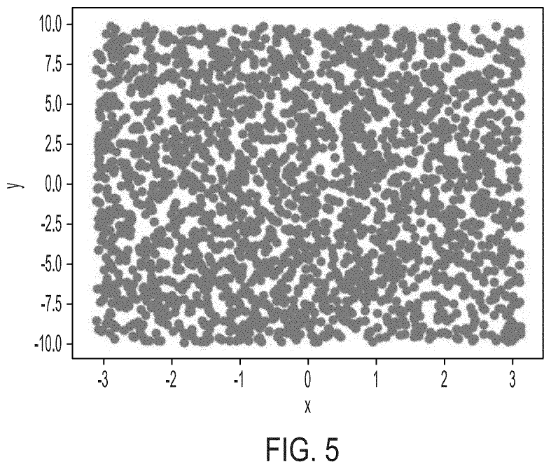

For example, let X denote the input space, assumed to be a compact set. Then, start with initial grid structure covering Xᵢ such that X=Uᵢ₌₁^{m}Xᵢ, where m denotes non-overlapping sets Xᵢ. Then, assign a uniform probability to select a particular grid, i.e., pᵢ=1/m. Then, execute a first sampling process by selecting grid i with probability pᵢ, followed by a uniform sampling from the interior of grid Xᵢ. FIG. 5 shows the sampling results where the grid structure has 25 elements, and a total budget of 2500 samples. Next, compute the sensitivities of the solution of the nonlinear system (the angular acceleration) with respect to the known variables (angle and angular velocity). More formally, let F(y; x)=0 be the nonlinear equation being solved, where y is a function of x. For every possible choice of x, F(y(x); x)=0, hence

$$\frac{dF}{dx} = 0.$$

By expending the previous derivative,

$$\frac{d F}{d x} = \frac{d F}{d y} \frac{d y}{d x} + \frac{d F}{d x} = 0 and \frac{d F}{d x} = - {( \frac{d F}{d y} )}^{- 1} \frac{d F}{d x} = 0 ,$$

where all quantities are evaluated at the solution y=y(x). For each input choice, the solution for each choice can be computed using the CVODE DAE solver (or other suitable solver). In this example, the automatic differentiation feature of Autograd was used to compute the sensitivity of the solution with respect to the inputs and the solution, that is, the quantities

$$\frac{d \ddot{φ}}{d \dot{φ}} , and \frac{d \dot{φ}}{d φ} .$$

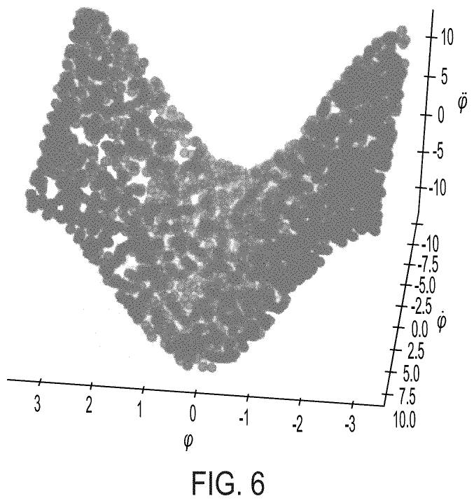

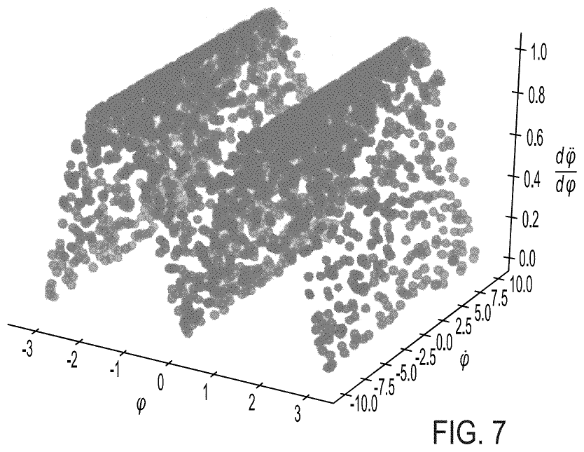

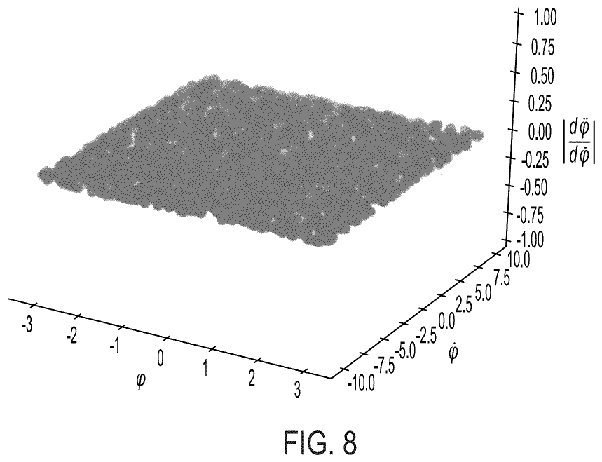

The solution of the nonlinear equations (i.e., the angular acceleration as a function of the angle and angular velocity in this example) is shown in FIG. 6. The normalized magnitudes of the two sensitivities are shown in FIGS. 7 and 8, respectively.

Based on the sensitivity magnitudes, the probabilities assigned to each subset Xᵢ may be modified so that more from the subsets corresponding to higher sensitivity magnitude values may be sampled. For each sensitivity, the average sensitivity value in a grid may be computed. For example, let sᵢ denote the normalized sensitivity magnitude for the i^{th} sensitivity. The average normalized sensitivity magnitude corresponding to subset Xⱼ is computed as

$${s}_{i}^{- j} = \frac{1}{\vert {X}_{j} \vert} {\sum }_{x ∈ {X}_{j}} {s}_{i} ( x ) .$$

These quantities can then be transformed into probabilities by normalizing them, i.e.,

$${p}_{i}^{j} = \frac{1}{{\sum }_{{ls}_{i}^{- l}}} {s}_{l}^{- j} .$$

The results from all sensitivities can be combined by computing their product and normalizing them:

$${p}^{- j} = {\prod }_{i} {p}_{i}^{j} and {p}^{j} = \frac{1}{{Σ}_{l} {p}^{- l}} {p}^{- j} .$$

This operation considers the magnitudes of all sensitivities when assigning a weight to a subset Xⱼ. No sensitivity is favored since the normalized magnitude values are used.

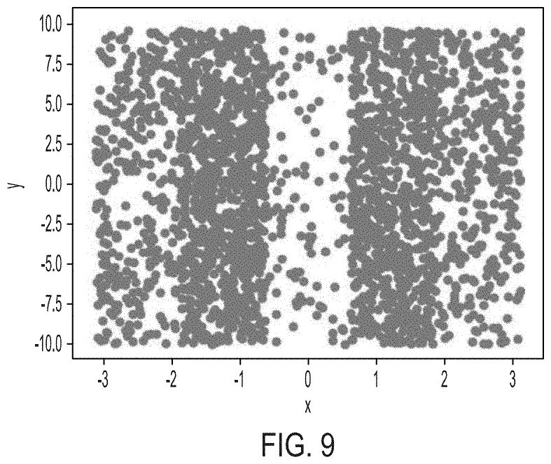

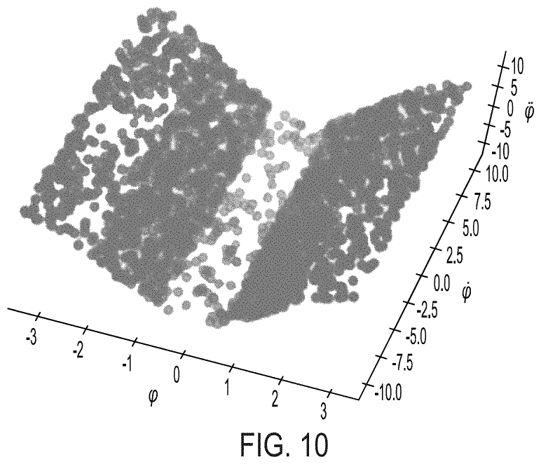

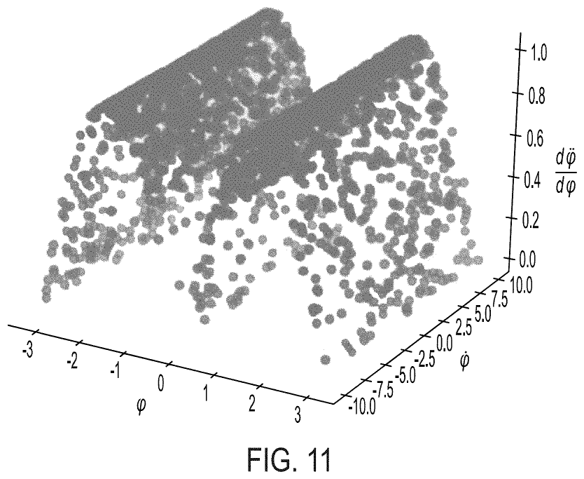

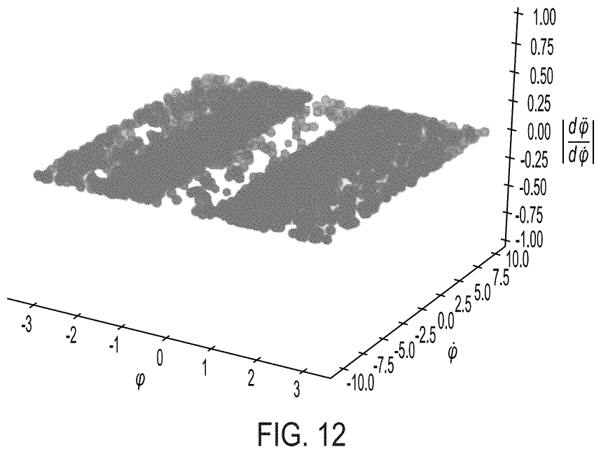

This sensitivity-based sampling approach to generate training data was applied to the pendulum example. Using the same 2500 samples budget, the samples drawn using the new grid probabilities are illustrated in FIG. 9. As shown in FIG. 9, the region around the zero on the x-axis has lower probability since the sensitivity of the acceleration with respect to the angle is the lowest in that area. The solution of the nonlinear equation, and its normalized sensitivity magnitudes are shown in FIGS. 10, 11, and 12, respectively.

Whether using a uniform sampling approach, a sensitivity-based sampling approach, or another approach to generate the training data, an advantage of the methods described herein is that large amounts of training data may be generated, which improves the accuracy of the final explicit dynamic ODE model.

Further, whether using a uniform sampling approach, a sensitivity-based sampling approach, or another approach to generate the training data, ultimately, the methods described herein modify the original implicit dynamic DAE model by replacing nonlinear equation with surrogate causal models that compute solutions directly without the need for applying a Newton-Raphson algorithm. Since no model is perfect, the surrogate causal model will introduce some prediction error. Methods described herein may optionally account for the prediction error.

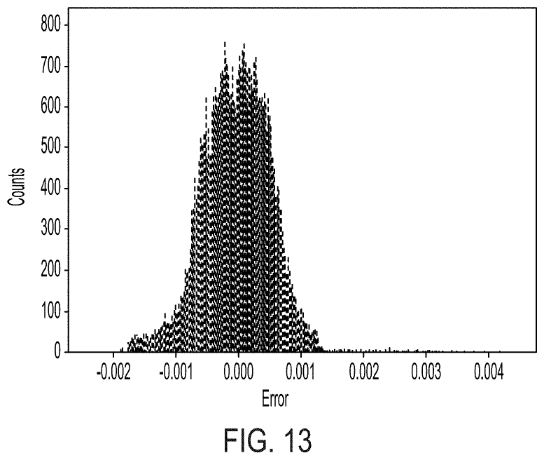

For example, a probabilistic model may be used to estimate the prediction error. Let y be the solution of a nonlinear block, and let ŷ be the solution predicted by its corresponding surrogate causal model. Define the prediction error as ε=y−ŷ. Using the training data, a data set of prediction errors can be generated, whose histogram is shown in FIG. 13. There are two options for fitting a distribution over the prediction errors: (a) fit parameters of known distributions (e.g., normal, beta, gamma, cauchy, and so on) or (b) learn a probability density function by using the histogram as training data. For the latter, a function f(x; β) was defined on which the density constraints (e.g., positive and its integral is one) were imposed. Then, the parameters of f(x; β) were trained.

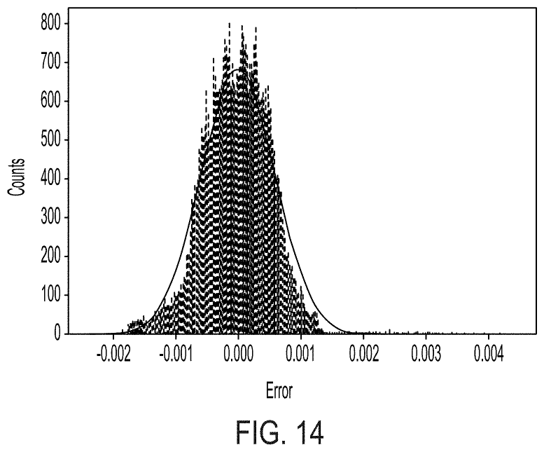

For the pendulum example, the first approach was chosen. Based on the graph shown in FIG. 13, the best fit is a normal distribution with mean −5.934496×10⁻⁶ and variance 0.00058704143. The fitted normal distribution superimposed on the prediction error histogram is shown in FIG. 14.

By replacing the nonlinear equation with a surrogate causal model, an additional source of randomness was introduced. Therefore, the system of equations for the pendulum with surrogate causal model insertion and accounting for the additional source of randomness can be expressed as EQ. 16-19 instead of EQ. 13-15.

\ddot{φ}=W^{[1]}(tanh(W^{[0]}[φ, \dot{φ}]^{T}+b^{[0]}))+b^{[1]}, φ(0)=φ₀, \dot{φ}(0)=\dot{φ}₀ (EQ. 16)

\ddot{φ}=\hat{\ddot{φ}}+ε, ε˜N(μ, σ²) (EQ. 17)

x=L cos(φ) (EQ. 18)

y=L sin(φ) (EQ. 19)

where N is normal (or Gaussian) distribution, μ is the mean of the distribution, and σ is the standard deviation.

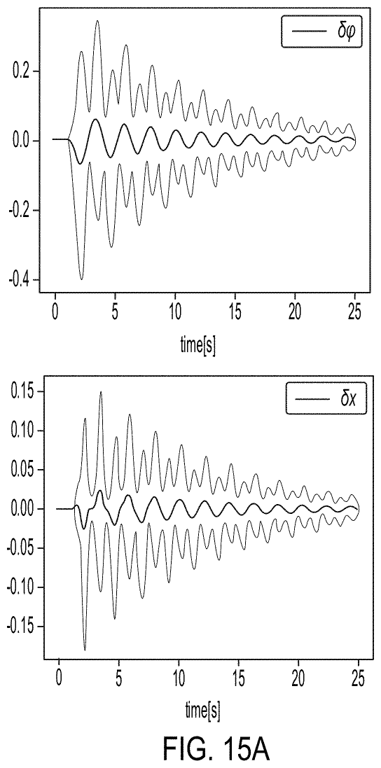

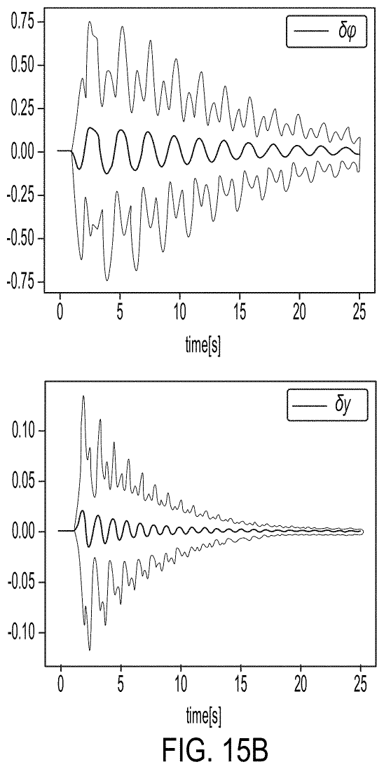

One option for estimating the effects the surrogate causal model have on the model is to perform Monte-Carlo simulations and learn the statistics of the errors between the solution of the original implicit dynamic DAE model and the solution of the explicit dynamic ODE model. For the pendulum example using the uniform sampling approach to generate the training data, Monte-Carlo simulations were performed to estimate the uncertainty statistics of the explicit dynamic ODE model EQ. 13-15. 1,000 random initial conditions for the angle and angular velocity were generated taking values in [−π/2, π/2] and [−5, 5], respectively. For each simulation, at each time during the simulation when the surrogate causal model is called to compute the acceleration, the error term drawn from a normal distribution was added to account for the prediction error. The mean and standard deviation for the variable errors were computed over time denoted by δφ, δ\dot{φ}, δx, and δy as shown in FIGS. 15A and 15B. In the shown example, it was assumed that distributions over time are normally distributed. As in the case of the prediction error of the surrogate causal model, a class of distributions can be fit where the best fit is preferably chosen.

An alternative to Monte-Carlo simulations for uncertainty quantification is an approach based on polynomial chaos methods and their generalization. Under this approach, moments of the variable error statistics can be computed similar to the Monte-Carlo approach.

The following is another nonlimiting example implementation of the methods described herein. This example is for controlling a chemical process.

Chemical processes are naturally modeled by systems of coupled differential and algebraic equations. This example specifically considers a reactor with fast and slow reactions with the objective being to transform its implicit dynamic DAE model into an explicit dynamic ODE model. The explicit dynamic ODE model may then be applied to control the physical system from which the implicit dynamic DAE model was derived.

The considered DAE model describes two first order reactions, where a reactant A is fed at a volumetric flowrate Fᵢ and concentration C_{Ai}, and the reactions A [symbol] B and B→C occur in series. The reversible reaction A [symbol] B is much faster than the irreversible B→C. Therefore, A [symbol] B is practically at equilibrium. The implicit dynamic DAE model governing the behavior of the two reactions is given by EQ. 20-25.

$$\frac{dV}{d T} = {F}_{i} - F \qquad ( EQ . 20 )$$

$$\frac{d {C}_{A}}{dt} = \frac{{F}_{i}}{V} ( {C}_{A i} - {C}_{A} ) - {R}_{A} \qquad ( EQ . 21 )$$

$$\frac{d {C}_{B}}{d t} = - \frac{{F}_{i}}{V} {C}_{B} + {R}_{A} - {R}_{B} \qquad ( EQ . 22 )$$

$$\frac{d {C}_{C}}{d t} = - \frac{{F}_{i}}{V} {C}_{C} + {R}_{B} \qquad ( EQ . 23 )$$

$$0 = {C}_{A} - \frac{{C}_{B}}{{K}_{e q}} \qquad ( EQ . 24 )$$

$$0 = {R}_{B} - {K}_{B} {C}_{B} \qquad ( EQ . 25 )$$

where V is the volume of liquid in the reactor, C_{A}, C_{B}, and C_{C} are the molar concentrations of the corresponding components, R_{A} and R_{B} are the reaction rates for the reversible and irreversible reactions, respectively, t is time, T is temperature, K_{eq} and K_{B} are reaction process parameters.

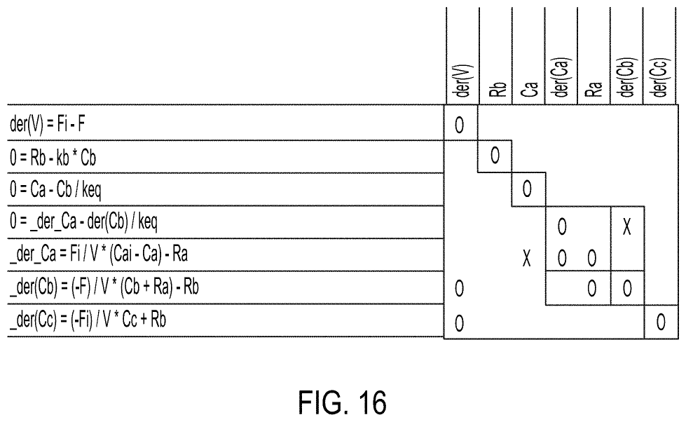

The control inputs for the reactions are the volumetric flow rates Fi and F. The reactor model is an implicit dynamic DAE model with index two. The control objective is to maintain the liquid volume V and the concentration of product B (CB) at some desired reference values. The structural analysis applied to implicit dynamic DAE model (EQ. 20-25) generates the BLT representation illustrated in FIG. 16. The index reduction algorithm introduced the dummy variable Ċ_{A} that decouples the computation of C_{A} from its time derivative

$$\frac{d {C}_{A}}{d t} .$$

The unknown variables of the diagonal in the BLT representation are Ċ_{A},

$$\frac{d {C}_{B}}{dt} ,$$

and R_{A}. The solution was computed as a function of the system variables Fᵢ, F, V, C_{A}, C_{B}, and R_{B}. A quick exploration of the BLT representation shows the variable R_{B} can be eliminated since it depends linearly on C_{B}. Then, let

$${y}^{T} = [ {\dot{C}}_{A} , \frac{d {C}_{B}}{dt} , {R}_{A} ] and {u}^{T} = [ {F}_{i} , F , V , {C}_{A} , {C}_{B} ] .$$

The objective was then to determine an explicit model y=f (u; w) that computes the solution of the diagonal block. In the case of the pendulum model neural networks were used for modeling f (u; w). In this example, a more traditional machine learning (ML) approach was used, where a set of features were engineered, and a regression problem was formulated. The training data was generated by randomly sampling the input space. Then, the BLT representation diagonal block is expressed as EQ. 26-28.

$$0 = {\dot{C}}_{A} - \frac{1}{{K}_{e q}} \frac{d {C}_{B}}{d t} \qquad ( EQ . 26 )$$

$${\dot{C}}_{A} = \frac{{F}_{i}}{V} ( {C}_{A i} - {C}_{A} ) - {R}_{A} \qquad ( EQ . 27 )$$

$$\frac{d {C}_{B}}{d t} = - \frac{F}{V} {C}_{B} + {R}_{A} - {K}_{B} {C}_{B} \qquad ( EQ . 28 )$$

When sampling the input space the underlying physical constraints that apply to the system variables that were considered were: non-negative volumetric flowrates, non-negative liquid volume, and non-negative component concentrations. The following feature vector x was defined as x=[x₁, x₂, x₃, x₄, x₁x₄, x₂x₃, x₁x₂, x₁x₃, x₂x₄, x₃x₄]^{T}, where x₁=Fᵢ/V, x₂=F/V, x₃=C_{B}, and x₄=C_{A}. The linear regression model was yⱼ=wⱼ^{T}x, where y₁=C_{A}, y₂=C_{B}, and y₃=R_{A}. Table 1 shows the results of training the parameters of the regression model.

TABLE 1

| | |
|---|---|
| w₁^{T} | [3.333e+01, 5.432e−14, −2.000e−01, |
| | 6.418e−14, −6.666e−01, −6.666e−01, |
| | 1.352e−15, −8.850e−16, −1.612e−16, 1.123e−15] |
| w₂^{T} | [1.666e+01, 2.7164e−14, −1.000e−01, |
| | 3.209e−14, −3.333e−01, −3.333e−01, |
| | 6.761e−16, −4.425e−16, −8.061e−17, 5.619e−16] |
| w₃^{T} | [1.666e+01, −2.377e−14, 2.000e−01, −1.359e−14, −3.333e−01, |
| | 6.666e−01, −7.721e−17, −1.704e−16, −1.270e−15, 1.406e−15] |

For this particular example, the EQ. 26-28 are linear. Generally, for small to medium size linear systems, symbolic calculus can be used to compute the solutions to the linear systems. For large linear systems of equations or nonlinear systems of equations, symbolic calculus may fail, and numerically learning a model for their solutions (as done in this example) should be done.

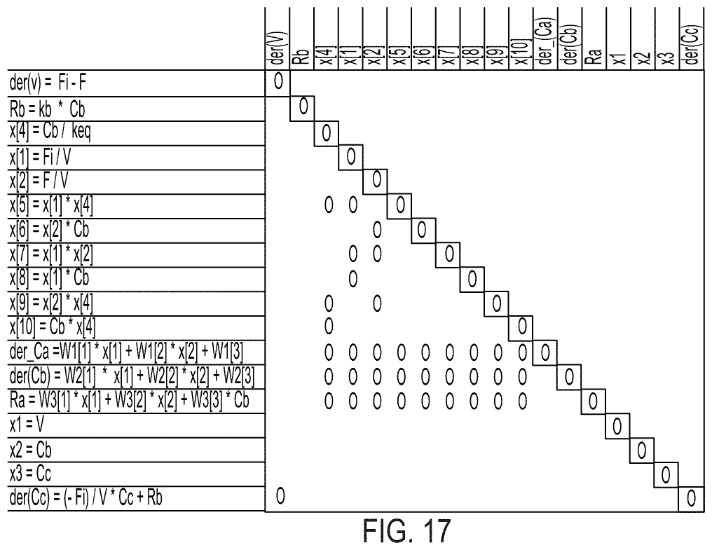

Returning to the chemical process example, the updated BLT representation accounting for the surrogate causal model is illustrated in FIG. 17.

Therefore, the original implicit dynamic DAE model for the chemical process (EQ. 20-25) may now be expressed as an explicit dynamic ODE model per EQ. 29-33 with three state variables.

$$\frac{d V}{d T} := {F}_{i} - F \qquad ( EQ . 29 )$$

$${C}_{A} := \frac{{C}_{B}}{{K}_{e q}} \qquad ( EQ . 30 )$$

$$x := [ \frac{{F}_{i}}{V} , \frac{F}{V} , {C}_{B} , {C}_{A} , \frac{{F}_{i}}{V} {C}_{A} , \frac{F}{V} {C}_{B} , \frac{{F}_{i} F}{{V}^{2}} , \frac{{F}_{i}}{V} {C}_{B} , \frac{F}{V} {C}_{A} , {C}_{A} {C}_{B} ] \qquad ( EQ . 31 )$$

$$\frac{d {C}_{B}}{dt} = {w}_{2}^{T} x \qquad ( EQ . 32 )$$

$$\frac{d {C}_{C}}{dt} = \frac{{F}_{i}}{V} {C}_{C} + {K}_{B} {C}_{B} \qquad ( EQ . 33 )$$

Further, by substituting the variable C_{A} in x as a function of C_{B}, the familiar form of an explicit dynamic ODE model is obtained.

The control objective described above is, more specifically, to stabilize the system at some desired equilibrium point (or steady-state (ss)), which here is defined as C_{B}^{ss}=11 mol/liter and V^{ss}=50 liters. Using EQ. 26-30, the remaining steady state variables and inputs can be solved for: Fᵢ^{ss}=9.705 liters/sec,

$${F}^{s s} = 9.705 \frac{liters}{s e c} ,$$

and C_{C}^{ss}=17.0 mol/liter. There are a plethora of control techniques that can be used to stabilize the chemical process system (reactor). As an example, a linear controller was designed for the linearized system model at the equilibrium point. The automatic differentiation feature of Autograd was used to generate the linear model. In particular, given the nonlinear explicit dynamic ODE model \dot{x}=f (x, u), Jacobian matrices were calculated as

$$A = \frac{\partial f}{\partial x} ( {x}^{ss} , {u}^{s s} ) and B = \frac{\partial f}{\partial u} ( {x}^{ss} , {u}^{s s} ) .$$

The linearized system is then given by

$$\frac{d Δ x}{dt} = A Δ x + B Δ u ,$$

where Δx=x−x^{ss} and Δu=u−u^{ss}, with

$$A = [ \begin{matrix}0 & 0 & 0 \\ - 0.022 & - 0.2941 & 0 \\ 0.0660 & 0.3 & - 0.1941\end{matrix} ] \\ B = [ \begin{matrix}1 & - 1 \\ 0.1867 & - 0.0733 \\ - 0.3400 & 0\end{matrix} ]$$

where the system parameters were chosen as: K_{eq}=0.5, K_{B}=0.3, and C_{Ai}=50 mol/liter.

A pole placement approach was used, where the matrix K=[k₁, k₂]^{T} is generated such the eigenvalues of the matrix A−BK are at p=[−0.1; −0.5; −0.3]. The control inputs Fᵢ and F are computed as Fᵢ=k₁^{T}(x−x^{ss})+Fᵢ^{ss} and F=k₂^{T}(x−x^{ss})+F^{ss}, where x=[V, C_{B}, C_{C}]^{T}.

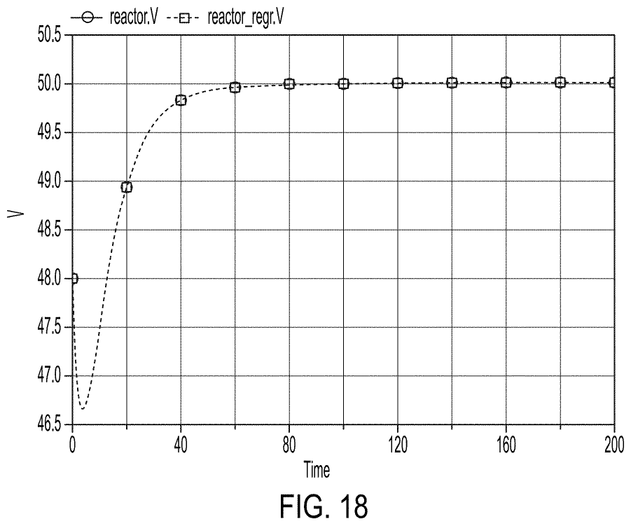

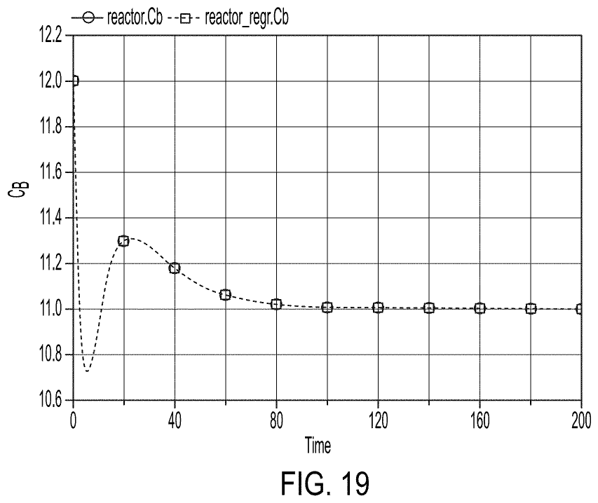

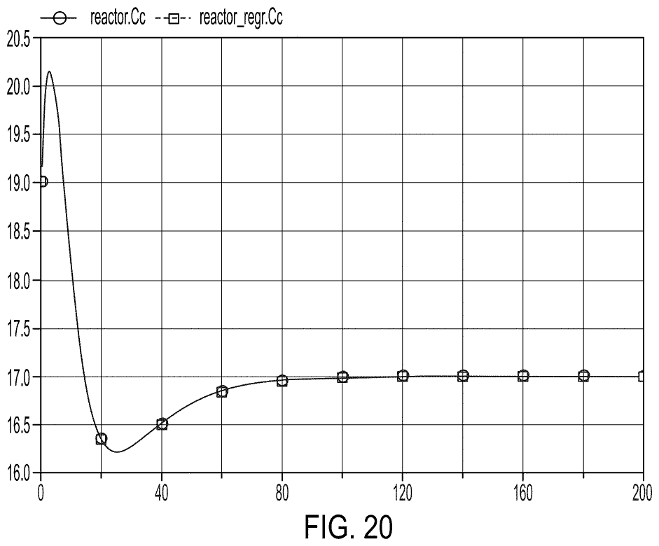

FIGS. 18, 19, and 20 show the evolution of the state variables under feedback control, as they stabilize at the desired equilibrium point. Each figure shows the state for both the linearized model (EQ. 29-33) and for the implicit dynamic DAE model (EQ. 20-25) when the inputs are generated by the linear controller.

The controller was tested for different initial conditions, empirically observing that the closed loop system has a large attractor. In general, uncertainty in the system model is expected by replacing nonlinear blocks with surrogate causal models. Such uncertainty can be quantified, as described in the case of the pendulum system. Once the uncertainty is quantified, robust control techniques can be used to account for it and to ensure the stability of the closed loop system.

The foregoing pendulum and chemical process reactor example are nonlimiting. The methods described herein may be applied to a variety of physical systems. Examples of physical systems to which the methods of the present disclosure may be applied include, but are not limited to, a chemical synthesis reactor; a distillation column; an automobile engine; heating, ventilation, and air conditioning (HVAC) systems; robots (e.g., for modeling robot dynamics, robot parts, robot part interactions, and the like); vehicles (e.g., for modeling vehicle dynamics, vehicle parts, vehicle part interactions and the like); electrical networks, distribution network systems; thermodynamic systems; and the like.

As described above, the explicit dynamic ODE model may be implemented relative to the physical system to which the implicit dynamic DAE model was derived. Implementation may include controlling the operation, diagnosing issues, and prognosticating conditions within a physical system.

In an example regarding controlling the operation of the physical system, a controller may be derived (e.g., as described above relative to the chemical process reactor) that uses and/or is based on the explicit dynamic ODE model. Advantageously, the explicit dynamic ODE model requires less computing time and resources. Therefore, the resultant controller may be more responsive (responsive over shorter time scales) in order to maintain system parameters and/or adjust system parameters.

In another example regarding controlling the operation of the physical system, a controller may be derived (e.g., as described above relative to the chemical process reactor) that uses a linear controller based on the explicit dynamic ODE model. Advantageously, the linear controller is derived using pole-placement methods and requires less computing time and resources since it is derived offline, before use.

In another example regarding controlling the operation of the physical system, a controller may be derived (e.g., as described above relative to the chemical process reactor) that uses optimal control algorithms such as linear quadratic regulator (LQR) controller based on the explicit linearized ODE model. Advantageously, the LQR controller is derived using optimal control algorithms and offer best control performance based on an optimization cost (e.g., minimize the control input energy).

In another example regarding controlling the operation of the physical system, a controller may be derived (e.g., as described above relative to the chemical process reactor) that uses optimal control algorithms such as model predictive control (MPC) based on the explicit linearized ODE model. Advantageously, the MPC controller is derived using optimal control algorithms and offers best control performance based on an optimization cost that can include constraints on both the system state and control inputs (e.g., bounding the state and input variables).

In an example regarding prognosticating conditions, models similar to the controller may be derived where theoretical system parameters (e.g., future system parameter settings) may be input and the corresponding system conditions output. Individual system conditions may have thresholds which inform the extent to which individual system parameters may be changed to stay within the bounds of the thresholds. Advantageously, the explicit dynamic ODE model requires less computing time and resources. Therefore, a greater number of scenarios may be investigated to determine the prognosticated conditions and limits to which system parameters may be adjusted.

In another example regarding diagnosis of the physical system, a diagnosis engine based on the explicit linearized ODE model can be derived. The diagnosis engine can use causal analysis based on constraint satisfaction to detect and isolate faults in the system. Advantageously, the causal analysis methods require a causal representation of the model, a requirement satisfied by explicit ODEs, unlike implicit DAEs.

The methods described herein may, and in many embodiments must, be performed, at least in part, using computing devices or processor-based devices that include a processor; a memory coupled to the processor; and instructions provided to the memory, wherein the instructions are executable by the processor to perform the methods described herein (such as computing or processor-based devices may be referred to generally by the shorthand “computer”).

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

For example, a system may comprise: a processor; a memory coupled to the processor; and instructions provided to the memory, wherein the instructions are executable by the processor to cause the system to: perform a block lower triangular (BLT) transformation on equations of an implicit dynamic differential algebraic equation (DAE) model to yield a BLT representation of the implicit dynamic DAE model; perform a nonlinear block extraction for a diagonal of the BLT representation of the implicit dynamic DAE model to yield one or more nonlinear blocks and one or more linear blocks; construct a surrogate causal model for each of the one or more nonlinear blocks; train the surrogate causal model for each of the one or more nonlinear blocks; and construct an explicit dynamic ordinary differential equation (ODE) model that corresponds to the implicit dynamic DAE model based on the linear blocks and the surrogate causal model.

In another example, a system may comprise: a processor; a memory coupled to the processor; and instructions provided to the memory, wherein the instructions are executable by the processor to cause the system to control system variables for a chemical reactor (or other physical system like a distillation column; an automobile engine; an HVAC system; a robot or a portion thereof; a vehicle or a portion thereof; an electrical network; a distribution network system; a thermodynamic system) using a controller based on an explicit dynamic ordinary differential equation (ODE) model derived from an implicit dynamic differential algebraic equation (DAE) model, wherein the derivation uses a block lower triangular (BLT) transformation of the DAE model and a trained surrogate causal model that replaces nonlinear blocks of the BLT.

### EXAMPLE EMBODIMENTS

A first nonlimiting embodiment of the present disclosure is a method comprising: performing a block lower triangular (BLT) transformation on equations of an implicit dynamic differential algebraic equation (DAE) model to yield a BLT representation of the implicit dynamic DAE model; performing a nonlinear block extraction for a diagonal of the BLT representation of the implicit dynamic DAE model to yield one or more nonlinear blocks and one or more linear blocks; constructing a surrogate causal model for each of the one or more nonlinear blocks; training the surrogate causal model for each of the one or more nonlinear blocks; and constructing an explicit dynamic ordinary differential equation (ODE) model that corresponds to the implicit dynamic DAE model based on the linear blocks and the surrogate causal model. The first nonlimiting example embodiment may further include one or more of: Element 1: the method further comprising: performing repeated differentiation of the implicit dynamic DAE model, or a portion thereof, to produce index reduction algorithms; and wherein the equations of the implicit dynamic DAE model include the index reduction algorithms; Element 2: wherein training the surrogate causal model comprises: solving nonlinear equations identified in the nonlinear block extraction in isolation from the linear blocks; Element 3: wherein training the surrogate causal model comprises: modeling the surrogate causal model using a deep learning platform; and training parameters of the surrogate causal model; Element 4: wherein training the surrogate causal model uses training data derived using a uniform sampling approach; Element 5: wherein training the surrogate causal model uses training data derived using a sensitivity-based sampling approach; Element 6: wherein training the surrogate causal model uses a neural network architecture; Element 7: wherein training the surrogate causal model uses a machine learning architecture; Element 8: wherein the explicit dynamic ODE model is also based on a randomness of the surrogate casual model; Element 9: the method further comprising: performing Monte-Carlo simulations on the implicit dynamic DAE model; estimating the uncertainty statistics of the explicit dynamic ODE model based on the Monte-Carlo simulations; and incorporating the uncertainty statistics into the explicit dynamic ODE model; Element 10: the method further comprising: applying polynomial chaos methods to the implicit dynamic DAE model; estimating the uncertainty statistics of the explicit dynamic ODE model based on the polynomial chaos methods; and incorporating the uncertainty statistics into the explicit dynamic ODE model; Element 11: wherein the implicit dynamic DAE model is associated with a physical system (e.g., a chemical synthesis reactor; a distillation column; an automobile engine; heating, ventilation, and air conditioning (HVAC) systems; robots and parts thereof; vehicles and parts thereof; electrical networks, distribution network systems; thermodynamic systems; and the like); Element 12: Element 11 and the method further comprising: collecting data from the physical system; updating the implicit dynamic DAE model based on the data; and updating the explicit dynamic ODE model based on the updated implicit dynamic DAE; Element 13: Element 11 and the method further comprising: controlling operational parameters of the physical system based on the explicit dynamic ODE model; Element 14: Element 11 and the method further comprising: controlling operational parameters of the physical system using a feedback controller based on the explicit dynamic ODE model; Element 15: Element 11 and the method further comprising: changing operational parameters and/or hardware of the physical system based on the explicit dynamic ODE model; Element 16: Element 11 and the method further comprising: diagnosing an issue with the physical system based on the explicit dynamic ODE model; and Element 17: Element 11 and the method further comprising: prognosticating conditions in the physical system based on the explicit dynamic ODE model; and changing operational parameters and/or hardware of the physical system based on the prognosticated conditions. Example combinations include, but are not limited to, Element 1 in combination with one or more of Elements 2-17; Element 2 in combination with one or more of Elements 3-17; Element 3 in combination with one or more of Elements 4-17; Element 4 in combination with one or more of Elements 5-17; Element 5 in combination with one or more of Elements 6-17; Element 6 or 7 in combination with one or more of Elements 8-17; Element 8 in combination with one or more of Elements 9-17; Element 9 or 10 in combination with one or more of Elements 11-17; Element 11 in combination with one or more of Elements 12-17; Elements 11 and 12 in combination with one or more of Elements 13-17; Elements 11 and 13 in combination with one or more of Elements 14-17; Elements 11 and 14 in combination with one or more of Elements 15-17; Elements 11 and 15 in combination with one or more of Elements 16-17; and Elements 11, 16, and 17 in combination.

A second nonlimiting embodiment of the present disclosure is a system comprising: a processor; a memory coupled to the processor; and instructions provided to the memory, wherein the instructions are executable by the processor to cause the method of the first nonlimiting example embodiment (optionally including one or more of Elements 1-17) to be performed.

A third nonlimiting embodiment of the present disclosure is a method comprising: controlling system variables for a chemical reactor (or other physical system like a distillation column; an automobile engine; an HVAC system; a robot or a portion thereof; a vehicle or a portion thereof; an electrical network; a distribution network system; a thermodynamic system) using a controller based on an explicit dynamic ordinary differential equation (ODE) model derived from an implicit dynamic differential algebraic equation (DAE) model, wherein the derivation uses a block lower triangular (BLT) transformation of the DAE model and a trained surrogate causal model that replaces nonlinear blocks of the BLT. The method may further include the derivation of the explicit ODE according to the method of the first nonlimiting example embodiment (optionally including one or more of Elements 1-10).

A fourth nonlimiting embodiment of the present disclosure is the chemical reactor (or other physical system like a distillation column; an automobile engine; an HVAC system; a robot or a portion thereof; a vehicle or a portion thereof; an electrical network; a distribution network system; a thermodynamic system) comprising: a processor; a memory coupled to the processor; and instructions provided to the memory, wherein the instructions are executable by the processor to cause the method of the third nonlimiting example embodiment (optionally including one or more of Elements 1-10) to be performed.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
performing a block lower triangular (BLT) transformation on equations of an implicit dynamic differential algebraic equation (DAE) model to yield a BLT representation of the implicit dynamic DAE model;
performing a nonlinear block extraction for a diagonal of the BLT representation of the implicit dynamic DAE model to yield one or more nonlinear blocks and one or more linear blocks;
constructing a surrogate causal model for each of the one or more nonlinear blocks;
training the surrogate causal model for each of the one or more nonlinear blocks; and
constructing an explicit dynamic ordinary differential equation (ODE) model that corresponds to the implicit dynamic DAE model based on the linear blocks and the surrogate causal model.

2. The method of claim 1 further comprising:
performing repeated differentiation of the implicit dynamic DAE model, or a portion thereof, to produce index reduction algorithms; and
wherein the equations of the implicit dynamic DAE model include the index reduction algorithms.

3. The method of claim 1, wherein training the surrogate causal model comprises:
solving nonlinear equations identified in the nonlinear block extraction in isolation from the linear blocks.

4. The method of claim 1, wherein training the surrogate causal model comprises:
modeling the surrogate causal model using a deep learning platform; and
training parameters of the surrogate causal model.

5. The method of claim 1, wherein training the surrogate causal model uses training data derived using a uniform sampling approach.

6. The method of claim 1, wherein training the surrogate causal model uses training data derived using a sensitivity-based sampling approach.

7. The method of claim 1, wherein training the surrogate causal model uses a neural network architecture.

8. The method of claim 1, wherein training the surrogate causal model uses a machine learning architecture.

9. The method of claim 1, wherein the explicit dynamic ODE model is also based on a randomness of the surrogate casual model.

10. The method of claim 1 further comprising:
performing Monte-Carlo simulations on the implicit dynamic DAE model;
estimating the uncertainty statistics of the explicit dynamic ODE model based on the Monte-Carlo simulations; and
incorporating the uncertainty statistics into the explicit dynamic ODE model.

11. The method of claim 1 further comprising:
applying polynomial chaos methods to the implicit dynamic DAE model;
estimating the uncertainty statistics of the explicit dynamic ODE model based on the polynomial chaos methods; and
incorporating the uncertainty statistics into the explicit dynamic ODE model.

12. The method of claim 1, wherein the implicit dynamic DAE model is associated with a physical system.

13. The method of claim 12 further comprising:
collecting data from the physical system;
updating the implicit dynamic DAE model based on the data; and
updating the explicit dynamic ODE model based on the updated implicit dynamic DAE.

14. The method of claim 12 further comprising:
controlling operational parameters of the physical system based on the explicit dynamic ODE model.

15. The method of claim 12 further comprising:
controlling operational parameters of the physical system using a feedback controller based on the explicit dynamic ODE model.

16. The method of claim 12 further comprising:
changing operational parameters and/or hardware of the physical system based on the explicit dynamic ODE model.

17. The method of claim 12 further comprising:
diagnosing an issue with the physical system based on the explicit dynamic ODE model.

18. The method of claim 12 further comprising:
prognosticating conditions in the physical system based on the explicit dynamic ODE model; and
changing operational parameters and/or hardware of the physical system based on the prognosticated conditions.

19. A system comprising:
a processor;
a memory coupled to the processor; and
instructions provided to the memory, wherein the instructions are executable by the processor to perform the method of claim 1.

20. A method comprising:
controlling system variables for a chemical reactor using a controller based on an explicit dynamic ordinary differential equation (ODE) model derived from an implicit dynamic differential algebraic equation (DAE) model, wherein the derivation uses a block lower triangular (BLT) transformation of the DAE model and a trained surrogate causal model that replaces nonlinear blocks of the BLT.
